(19) United States
(12) Patent Application Publication
(10) Pub. No.: US 2007/0063979 A1
(43) Pub. Date: Mar. 22, 2007

(54) Systems and methods to provide input/output for a portable data processing device

(75) Inventor: Bao Q. Tran, San Jose, CA (US)

Correspondence Address: TRAN & ASSOCIATES, 6768 MEADOW VISTA CT., SAN JOSE, CA, 95135, US

(73) Assignee: AVAILABLE FOR LICENSING

(21) Appl. No.: 11/230,236

(22) Filed: Sep. 19, 2005

(51) Int. Cl. G09G 5/00

(52) U.S. Cl. 345/169

(57) ABSTRACT

Systems and methods are disclosed to provide input/output for a portable data device by projecting a keyboard pattern using a light projector; capturing one or more images of a user's digits on the keyboard pattern with a camera; decoding a character being typed on the keyboard pattern; and displaying the typed character using the light projector.

### BACKGROUND

The present invention relates to a portable data-processing device with multi-functional input/output peripheral.

Portable data processing devices such as cellular telephones have become ubiquitous due to the ease of use and the instant accessibility that the phones provide. For example, modem cellular phones provide calendar, contact, email, and Internet access functionalities that used to be provided by desktop computers. For providing typical telephone calling function, the cellular phone only needs a numerical keyboard and a small display. However, for advanced functionalities such as email or Internet access, full alphanumeric keyboards are desirable to enter text. Additionally, a large display is desirable for readability. However, such desirable features are at odds with the small size of the cellular phone.

Additionally, as the cellular phone takes over functions normally done by desktop computers, they carry sensitive data such as telephone directory, bank account and brokerage account information, credit card information, sensitive electronic mails (emails) and other personally identifiable information. The sensitive data needs to be properly secured. Yet, security and ease of use are requirements that are also at odds with each other.

### SUMMARY

Systems and methods are disclosed to provide input/output for a portable data device by projecting a keyboard pattern using a light projector; capturing one or more images of a user's digits or the keyboard pattern with a camera; decoding a character being typed on the keyboard pattern; and displaying the typed character using the light projector.

Implementations of the above apparatus may include one or more of the following. A radio transceiver can provide the processor the ability to communicate voice and data to a remote location. A swiveling base can be used to support the light projector. The light projector can project a screen image through a first head of the light projector and a keyboard image through a second head of the light projector. The light projector can also project a screen image and a keyboard image on a common surface. Alternatively, the light projector displays a screen image and a keyboard image on separate surfaces. The light-projector can also be used as a camera flash unit. The processor can authenticate a user using one of: retina image captured by a camera, face image captured by the camera, and voice characteristics captured by a microphone. The processor can also perform file conversion for one of: Outlook, Word, Excel, PowerPoint, Access, Acrobat, Photoshop, Visio, AutoCAD, among others.

### BRIEF DESCRIPTION OF THE FIGURES

FIG. 1 shows an exemplary portable data processing device.

FIG. 2 shows an exemplary process for providing input/output (I/O) to the device of FIG. 1.

FIG. 3 shows an exemplary cellular telephone embodiment.

FIG. 4 shows another exemplary cellular telephone embodiment with enhanced I/O.

FIG. 5 shows yet another exemplary cellular telephone with enhanced I/O.

### DESCRIPTION

Now, the present invention is more specifically described with reference to accompanying drawings of various embodiments thereof, wherein similar constituent elements are designated by similar reference numerals.

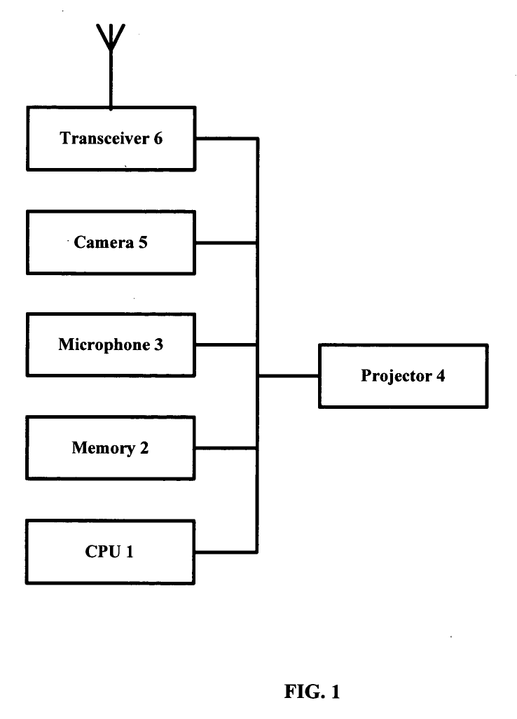

FIG. 1 shows an exemplary portable data-processing device having enhanced I/O peripherals. In one embodiment, the device has a processor 1 connected to a memory array 2 that can also serve as a solid state disk. The processor 1 is also connected to a light projector 4, a microphone 3 and a camera 5. A wireless transceiver 6 may be connected to the processor 1 to communicate with remote devices. For example, the wireless transceiver can be WiFi, WiMax, 802.X, Bluetooth, infra-red, cellular transceiver (CDMA/GPRS/EDGE), all, one or more, or any combination thereof.

The light projector 4 includes a light source such as a white light emitting diode (LED) or a semiconductor laser device or an incandescent lamp emitting a beam of light through a focusing lens to be projected onto a viewing screen. The beam of light can reflect or go through an image forming device such as a liquid crystal display (LCD) so that the light source beams light through the LCD to be projected onto a viewing screen.

Alternatively, the light projector 4 can be a MEMS device. In one implementation, the MEMS device can be a digital micro-mirror device (DMD) available from Texas Instruments, Inc., among others. The DMD includes a large number of micro-mirrors arranged in a matrix on a silicon substrate, each micro-mirror being substantially of square having a side of about 16 microns.

Another MEMS device is the grating light valve (GLV). The GLV device consists of tiny reflective ribbons mounted over a silicon chip. The ribbons are suspended over the chip with a small air gap in between. When voltage is applied below a ribbon, the ribbon moves toward the chip by a fraction of the wavelength of the illuminating light and the deformed ribbons form a diffraction grating, and the various orders of light can be combined to form the pixel of an image. The GLV pixels are arranged in a vertical line that can be 1,080 pixels long, for example. Light from three lasers, one red, one green and one blue, shines on the GLV and is rapidly scanned across the display screen at a number of frames per second to form the image.

In one implementation, the light projector 4 and the camera 5 face opposite surfaces so that the camera 5 faces the user to capture user finger strokes during typing while the projector 4 projects a user interface responsive to the entry of data. In another implementation, the light projector 4 and the camera 5 on positioned on the same surface. In yet another implementation, the light projector 4 can provide light as a flash for the camera 5 in low light situations.

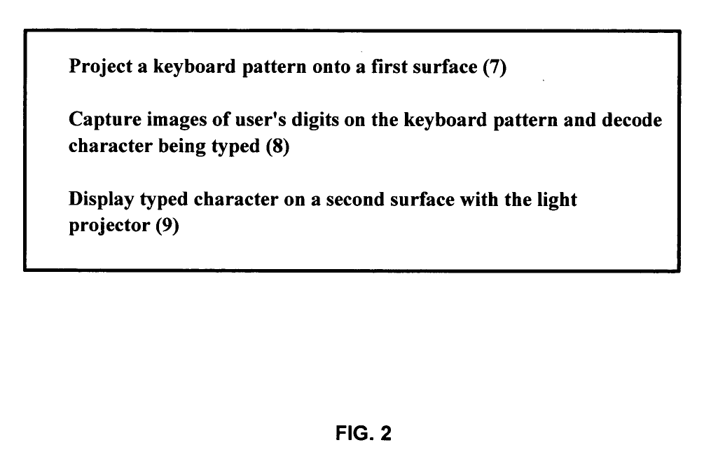

FIG. 2 shows an exemplary process executed by the system of FIG. 1. The process projects a keyboard pattern onto a first surface using the light projector (7). The camera 5 is used to capture images of user's digits on the keyboard pattern as the user types and digital images of the typing is decoded by the processor 1 to determine the character being typed (8). The processor 1 then displays typed character on a second surface with the light projector (9).

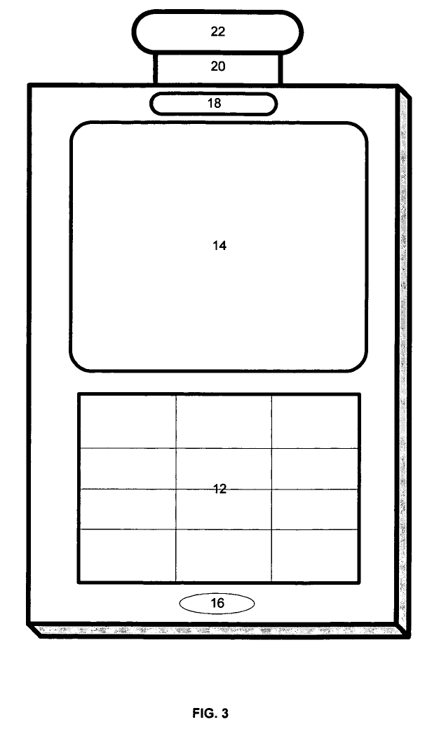

FIG. 3 shows one embodiment where the portable computer is implemented as a cellular phone 10. In FIG. 3, the cellular phone 10 has numeric keypad 12, a phone display 14, a microphone port 16, a speaker port 18. The phone 10 has dual projection heads mounted on the swivel base or rotatable support 20 to allow the heads to be swiveled by the user to adjust the display angle, for example. During operation, one head projects the user interface on a screen, while the other head displays a keyboard template onto a surface such as a table surface to provide the user with a virtual keyboard to “type” on. During operation, light from a light source internal to the phone 10 drives the heads. One head displays a screen for the user to view the output of processor 1, while the remaining head displays in an opposite direction the virtual keyboard using a predefined keyboard template. During operation, light from a light source internal to the phone 10 drives the heads. The head displays a screen for the user to view the output of processor 1, while the second head displays in an opposite direction the virtual keyboard using a predefined keyboard template. The first head projects the user interface on a first surface such as a display screen surface, while the second head displays a keyboard template onto a different surface such as a table surface to provide the user with a virtual keyboard to “type” on.

The light-projector can also be used as a camera flash unit. In this capacity, the camera samples the room lighting condition. When it detects a low light condition, the processor determines the amount of flash light needed. When the camera actually takes the picture, the light projector beams the required flash light to better illuminate the room and the subject.

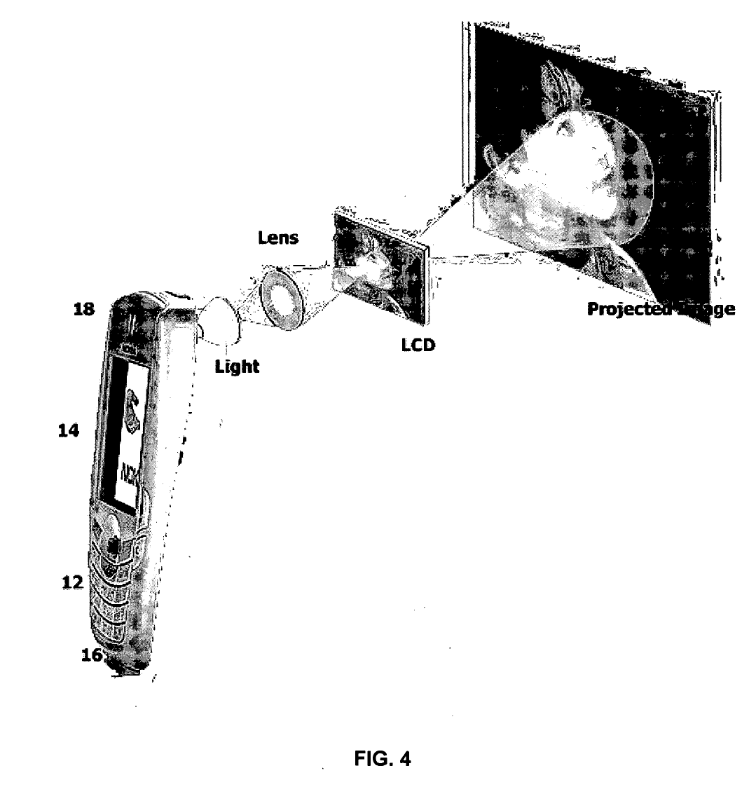

In one embodiment shown in FIG. 4, the phone 10 has a projection head that projects the user interface on a screen. During operation, light from a light source internal to the phone 10 drives the head that displays a screen for the user to view the output of processor 1. The head projects the user interface through a focusing lens and through an LCD to project the user interface rendered by the LCD onto a first surface such as a display screen surface.

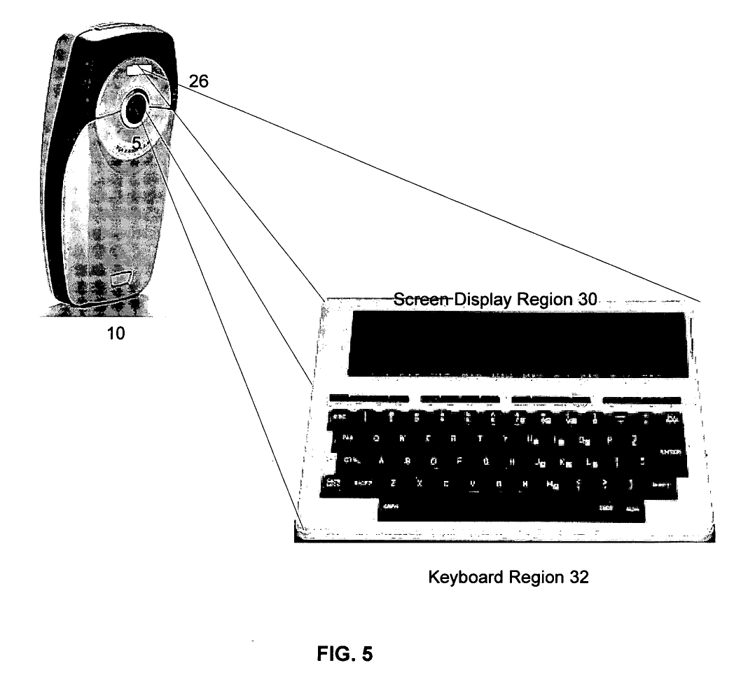

As shown in FIG. 5, in one embodiment, the head 26 displays a screen display region 30 in one part of the projected image and a keyboard region 32 in another part of the projected image. In this embodiment, the screen and keyboard are displayed on the same surface. During operation, the head 26 projects the user interface and the keyboard template onto the same surface such as a table surface to provide the user with a virtual keyboard to “type” on. Additionally, any part of the projected image can be “touch sensitive” in that when the user touches a particular area, the camera registers the touching and can respond to the selection as programmatically desired. This embodiment provides a virtual touch screen where the touch-sensitive panel has a plurality of unspecified key-input locations.

When user wishes to input some data on the touch-sensitive virtual touch screen, the user determines a specific angle between the cell phone to allow the image projector 24 or 26 to project a keyboard image onto a surface. The keyboard image projected on the surface includes an image of arrangement of the keypads for inputting numerals and symbols, images of pictures, letters and simple sentences in association with the keypads, including labels and/or specific functions of the keypads. The projected keyboard image is switched based on the mode of the input operation, such as a numeral, symbol or letter input mode. The user touches the location of a keypad in the projected image of the keyboard based on the label corresponding to a desired function. The surface of the touch-sensitive virtual touch screen for the projected image can have a color or surface treatment which allows the user to clearly observe the projected image. In an alternative, the touch-sensitive touch screen has a plurality of specified key-input locations such as obtained by printing the shapes of the keypads on the front surface. In this case, the keyboard image includes only a label projected on each specified location for indicating the function of the each specified location.

The virtual keyboard and display projected by the light projector are ideal for working with complex documents. Since these documents are typically provided in Word, Excel, PowerPoint, or Acrobat files, among others, the processor can also perform file conversion for one of: Outlook, Word, Excel, PowerPoint, Access, Acrobat, Photoshop, Visio, AutoCAD, among others.

Since high performance portable data devices can critical sensitive data, authentication enables the user to safely carry or transmit/receive sensitive data with minimal fear of compromising the data. The processor 1 can authenticate a user using one of: retina image captured by a camera, face image captured by the camera, and voice characteristics captured by a microphone.

In one embodiment, the processor 1 captures an image of the user's eye. The rounded eye is mapped from a round shape into a rectangular shape, and the rectangular shape is then compared against a prior mapped image of the retina.

In yet another embodiment, the user's face is captured and analyzed. Distinguishing features or landmarks are determined and then compared against prior stored facial data for authenticating the user. Examples of distinguishing land include the distance between ears, eyes, the size of the mouth, the shape of the mouth, the shape of the eyebrow, and any other distinguishing features such as scars and pimples, among others.

In yet another embodiment, the user's voice is recognized by a trained speaker dependent voice recognizer. Authentication is further enhanced by asking the user to dictate a verbal password.

To provide high security for bank transactions or credit transactions, a plurality of the above recognition techniques can be applied together. Hence, the system can perform retinal scan, facial scan, and voice scan to provide a high level of confidence that the person using the portable computing device is the real user.

Once digitized by the microphone and the camera, various algorithms can be applied to detect a pattern associated with a person. The signal is parameterized into features by a feature extractor. The output of the feature extractor is delivered to a sub-structure recognizer. A structure preselector receives the prospective sub-structures from the recognizer and consults a dictionary to generate structure candidates. A syntax checker receives the structure candidates and selects the best candidate as being representative of the person.

In one embodiment, a neural network is used to recognize each code structure in the codebook as the neural network is quite robust at recognizing code structure patterns. Once the speech or image features have been characterized, the speech or image recognizer then compares the input speech or image signals with the stored templates of the vocabulary known by the recognizer.

Data from the vector quantizer is presented to one or more recognition models, including an HMM model, a dynamic time warping model, a neural network, a fuzzy logic, or a template matcher, among others. These models may be used singly or in combination. The output from the models is presented to an initial N-gram generator which groups N-number of outputs together and generates a plurality of confusingly similar candidates as initial N-gram prospects. Next, an inner N-gram generator generates one or more N-grams from the next group of outputs and appends the inner trigrams to the outputs generated from the initial N-gram generator. The combined N-grams are indexed into a dictionary to determine the most likely candidates using a candidate preselector. The output from the candidate preselector is presented to a speech or image structure N-gram model or a speech or image grammar model, among others to select the most likely speech or image structure based on the occurrences of other speech or image structures nearby.

Dynamic programming obtains a relatively optimal time alignment between the speech or image structure to be recognized and the nodes of each speech or image model. In addition, since dynamic programming scores speech or image structures as a function of the fit between speech or image models and the speech or image signal over many frames, it usually gives the correct speech or image structure the best score, even if the speech or image structure has been slightly misspoken or obscured by background sound. This is important, because humans often mispronounce speech or image structures either by deleting or mispronouncing proper sounds, or by inserting sounds which do not belong.

In dynamic time warping, the input speech or image signal A, defmed as the sampled time values A=a(1) . . . a(n), and the vocabulary candidate B, defmed as the sampled time values B=b(1) . . . b(n), are matched up to minimize the discrepancy in each matched pair of samples. Computing the warping function can be viewed as the process of finding the minimum cost path from the beginning to the end of the speech or image structures, where the cost is a function of the discrepancy between the corresponding points of the two speech or image structures to be compared.

The warping function can be defined to be:
C=c(1), c(2), . . . , c(k), . . . c(K)
where each c is a pair of pointers to the samples being matched:
c(k)=[i(k), j(k)]

In this case, values for A are mapped into i, while B values are mapped into j. For each c(k), a cost function is computed between the paired samples. The cost function is defined to be:
d[c(k)]=(aᵢ₍ₖ₎−bⱼ₍ₖ₎)²

The warping function minimizes the overall cost function:

$$D ( C ) = {\sum }_{k = 1}^{K} d [ c ( k ) ]$$

subject to the constraints that the function must be monotonic
i(k)≧i(k−1)
and
j(k)≧j(k−1)
and that the endpoints of A and B must be aligned with each other, and that the function must not skip any points.

Dynamic programming considers all possible points within the permitted domain for each value of i. Because the best path from the current point to the next point is independent of what happens beyond that point. Thus, the total cost of [i(k), j(k)] is the cost of the point itself plus the cost of the minimum path to it. Preferably, the values of the predecessors can be kept in an M×N array, and the accumulated cost kept in a 2×N array to contain the accumulated costs of the immediately preceding column and the current column. However, this method requires significant computing resources.

The method of whole-speech or image structure template matching has been extended to deal with connected speech or image structure recognition. A two-pass dynamic programming algorithm to find a sequence of speech or image structure templates which best matches the whole input pattern. In the first pass, a score is generated which indicates the similarity between every template matched against every possible portion of the input pattern. In the second pass, the score is used to find the best sequence of templates corresponding to the whole input pattern.

Considered to be a generalization of dynamic programming, a hidden Markov model is used in the preferred embodiment to evaluate the probability of occurrence of a sequence of observations O(1), O(2), . . . O(t), . . . , O(T), where each observation O(t) may be either a discrete symbol under the VQ approach or a continuous vector. The sequence of observations may be modeled as a probabilistic function of an underlying Markov chain having state transitions that are not directly observable.

In the preferred embodiment, the Markov network is used to model a number of speech or image sub-structures. The transitions between states are represented by a transition matrix A=[a(ij)]. Each a(ij) term of the transition matrix is the probability of making a transition to state j given that the model is in state i. The output symbol probability of the model is represented by a set of functions B=[b(j) (O(t)], where the b(j) (O(t) term of the output symbol matrix is the probability of outputting observation O(t), given that the model is in state j. The first state is always constrained to be the initial state for the first time frame of the utterance, as only a prescribed set of left-to-right state transitions are possible. A predetermined final state is defined from which transitions to other states cannot occur.

Transitions are restricted to reentry of a state or entry to one of the next two states. Such transitions are defmed in the model as transition probabilities. For example, a speech or image signal pattern currently having a frame of feature signals in state 2 has a probability of reentering state 2 of a(2,2), a probability a(2,3) of entering state 3 and a probability of a(2,4)=1−a(2,1)−a(2,2) of entering state 4. The probability a(2,1) of entering state 1 or the probability a(2,5) of entering state 5 is zero and the sum of the probabilities a(2,1) through a(2,5) is one. Although the preferred embodiment restricts the flow graphs to the present state or to the next two states, one skilled in the art can build an HMM model without any transition restrictions, although the sum of all the probabilities of transitioning from any state must still add up to one.

In each state of the model, the current feature frame may be identified with one of a set of predefined output symbols or may be labeled probabilistically. In this case, the output symbol probability b(j) O(t) corresponds to the probability assigned by the model that the feature frame symbol is O(t). The model arrangement is a matrix A=[a(ij)] of transition probabilities and a technique of computing B=b(j) O(t), the feature frame symbol probability in state j.

The probability density of the feature vector series Y=y(1), . . . , y(T) given the state series X=x(1), . . . , x(T) is
[Precise Solution]

$${L}_{1} ( v ) = {\sum }_{x} P \{ Y , X \text{\textbar} {λ}^{v} \}$$

[Approximate Solution]

$${L}_{2} ( v ) = {max}_{x} [ P \{ Y , X \text{\textbar} {λ}^{v} \} ]$$

[Log Approximate Solution]

$${L}_{3} ( v ) = {max}_{x} [ log P \{ Y , X \text{\textbar} {λ}^{v} \} ]$$

The final recognition result v of the input speech or image signal x is given by: where n is a positive integer.

$$v = {arg max}_{v} [ {L}_{n} ( v ) ]$$

The Markov model is formed for a reference pattern from a plurality of sequences of training patterns and the output symbol probabilities are multivariate Gaussian function probability densities. The speech or image signal traverses through the feature extractor. During learning, the resulting feature vector series is processed by a parameter estimator, whose output is provided to the hidden Markov model. The hidden Markov model is used to derive a set of reference pattern templates, each template representative of an identified pattern in a vocabulary set of reference speech or image sub-structure patterns. The Markov model reference templates are next utilized to classify a sequence of observations into one of the reference patterns based on the probability of generating the observations from each Markov model reference pattern template. During recognition, the unknown pattern can then be identified as the reference pattern with the highest probability in the likelihood calculator.

The HMM template has a number of states, each having a discrete value. However, because speech or image signal features may have a dynamic pattern in contrast to a single value. The addition of a neural network at the front end of the HMM in an embodiment provides the capability of representing states with dynamic values. The input layer of the neural network comprises input neurons. The outputs of the input layer are distributed to all neurons in the middle layer. Similarly, the outputs of the middle layer are distributed to all output states, which normally would be the output layer of the neuron. However, each output has transition probabilities to itself or to the next outputs, thus forming a modified HMM. Each state of the thus formed HMM is capable of responding to a particular dynamic signal, resulting in a more robust HMM. Alternatively, the neural network can be used alone without resorting to the transition probabilities of the HMM architecture.

Although the neural network, fuzzy logic, and HMM structures described above are software implemnentations, nano-structures that provide the same functionality can be used. For instance, the neural network can be implemented as an array of adjustable resistance whose outputs are summed by an analog summer.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method to provide input/output for a portable data device, comprising:
projecting a keyboard pattern using a light projector;
capturing one or more images of a user's digits on the keyboard pattern with a camera;
decoding a character being typed on the keyboard pattern; and
displaying the typed character using the light projector.

2. The method of claim 1, wherein the portable data device includes a display, and wherein the display is placed in a low power mode when the light projector is displaying the typed character on the second surface.

3. The method of claim 1, comprising swiveling the light projector to view a displayed image.

4. The method of claim 1, comprising projecting a screen image through a first head of the light projector and projecting a keyboard image through a second head of the light projector.

5. The method of claim 1, comprising projecting a screen image and a keyboard image on a common surface using the light projector.

6. The method of claim 1, comprising projecting a screen image and a keyboard image on separate surfaces using the light projector.

7. The method of claim 1, comprising using the light-projector as a camera flash unit.

8. The method of claim 1, comprising authenticating a user using one of: retina image captured by a camera, face image captured by the camera, and voice characteristics captured by a microphone.

9. The method of claim 1, comprising authenticating by:
capturing a user's retina image;
capturing a user's face using the camera;
recognizing a user's voice; and
checking a cell phone SIM card identification.

10. The method of claim 1, comprising performing file conversion for one of: Outlook, Word, Excel, PowerPoint, Access, Acrobat, Photoshop, Visio, AutoCAD.

11. An apparatus to provide input/output for a portable data device, comprising:
a light projector to project a keyboard pattern and a display screen;
a camera to capture one or more images of a user's digits on the keyboard pattern;
a processor coupled to the light projector and the camera to decode a character being typed on the keyboard pattern and render the character on the display screen.

12. The apparatus of claim 11, comprising a radio transceiver coupled to the processor to communicate voice and data to a remote location.

13. The apparatus of claim 11, comprising swiveling base to support the light projector.

14. The apparatus of claim 11, comprising projecting a screen image through a first head of the light projector and projecting a keyboard image through a second head of the light projector.

15. The apparatus of claim 11, comprising projecting a screen image and a keyboard image on a common surface using the light projector.

16. The apparatus of claim 11, wherein the light projector displays a screen image and a keyboard image on separate surfaces.

17. The apparatus of claim 11, wherein the light-projector comprises a camera flash unit.

18. The apparatus of claim 11, wherein the processor authenticates a user using one of: a retina image captured by a camera, a face image captured by the camera, and voice characteristics captured by a microphone.

19. The apparatus of claim 11, wherein the processor authenticates a user by:
recognizing a user's retina image;
recognizing a user's face using the camera; and
recognizing a user's voice.

20. The apparatus of claim 11, comprising means for performing file conversion for one of: Outlook, Word, Excel, PowerPoint, Access, Acrobat, Photoshop, Visio, AutoCAD.
